(19) United States
(12) Patent Application Publication
(10) Pub. No.: US 2005/0100641 A1
(43) Pub. Date: May 12, 2005

(54) Dog bone treat and method for manufacturing the same

(76) Inventor: Yi-Jhih Lin, Chiayi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,579

(22) Filed: Nov. 12, 2003

(51) Int. Cl. A23G 1/00

(52) U.S. Cl. 426/132

(57) ABSTRACT

A method for making a dog bone treat includes the steps of: making a hollow inner cylindrical bone part from a cowhide, and heating and drying the inner cylindrical bone part; making an outer bone part from a cowhide, and wrapping the outer bone part around the inner bone part; making knots at two ends of the outer bone part to cover two ends of the inner bone part; heating and drying the outer bone part; making first and second holes on the outer and the inner bone parts respectively such that the second hole communicates with a holding room of the inner bone part, and such that the first hole is aligned with the second hole; injecting meat paste into the holding room, and a space between the inner and the outer bone parts via the first and the second holes; heating and drying the meat paste.

### BACKGROUND OF THE INVENTION

1. Field of the Invention

The present invention relates to a dog bone treat and method for manufacturing the same, which dog bone treat is comprised of an outer cowhide part, an inner cowhide part wrapped in the outer part, and meat paste held in the inner cowhide part as well as a space between the inner and the outer cowhide parts for attracting dogs to chewing on the bone treat.

2. Brief Description of the Prior Art

Dogs are usually given bone treats made of rawhides and meat paste for them to chew on. This is an effective way for them to keep their teeth and gums clean and healthy.

Referring to FIG. 1, a conventional dog bone treat 1 includes a bone part 11, and meat paste 12, which surrounds a middle portion of the bone part 11, and allows two ends of the bone part 11 to show. The meat paste 12 can attract a dog to chewing on the treat 1, but a dog will no longer like to chew on the treat 1 after it eats up the meat paste 12 because the bone part 11 has no flavor. This treat 1 becomes useless very soon because the bone part 11 is what can really help clean dogs' teeth and gums while a dog is not interested in chewing on a bone part without meat paste.

Referring to FIG. 2, another conventional dog bone treat 2 is only made of meat paste. This dog bone treat 2 is less effective than the above one 1 in helping clean dogs' teeth and gums because it has no bone part.

### SUMMARY OF THE INVENTION

It is a main object of the present invention to provide a dog bone treat to overcome the above disadvantages.

The dog bone treat of the present invention includes an inner bone part, an outer bone part, and a meat paste portion; the inner bone part has a holding room therein, and a hole in communication with the holding room; the outer bone part is wrapped around the inner bone part, and has knots at two ends thereof, and a hole aligned with the hole of the inner bone part; the meat paste portion is held in the holding room of the inner bone part as well as a space between the inner and the outer bone parts; thus, a dog will be attracted to chewing on the bone treat because it can smell, and eat the meat paste as long as the meat paste portion has not been eaten up.

### BRIEF DESCRIPTION OF THE DRAWINGS

This invention will be better understood by referring to the accompanying drawings, wherein:

FIG. 1 is a cross-sectional view of the first conventional dog bone treat described in the Background,

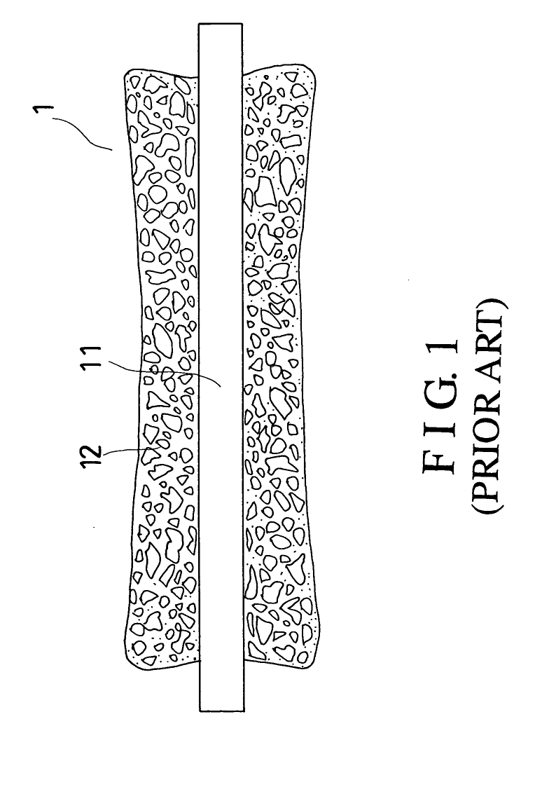

FIG. 2 is a perspective view of the second conventional dog bone treat,

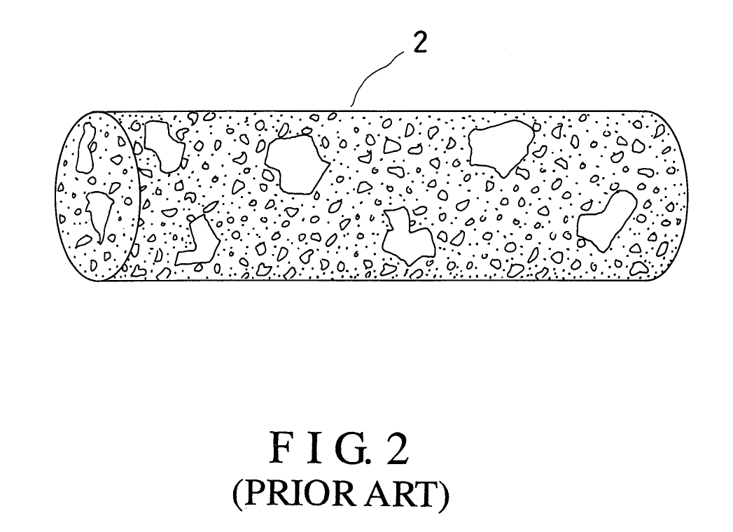

FIG. 3 is a flow chart of the method for manufacturing the dog bone treat according to the present invention,

FIG. 4 is a perspective view of the dog bone treat according to the present invention,

FIG. 5 is a top view of the dog bone treat of the present invention,

FIG. 6 is a vertical section of the dog bone treat according to the present invention, and

FIG. 7 is another vertical section of the dog bone treat according to the present invention.

### DETAILED DESCRIPTION OF THE PREFERRED EMBODIMENTS

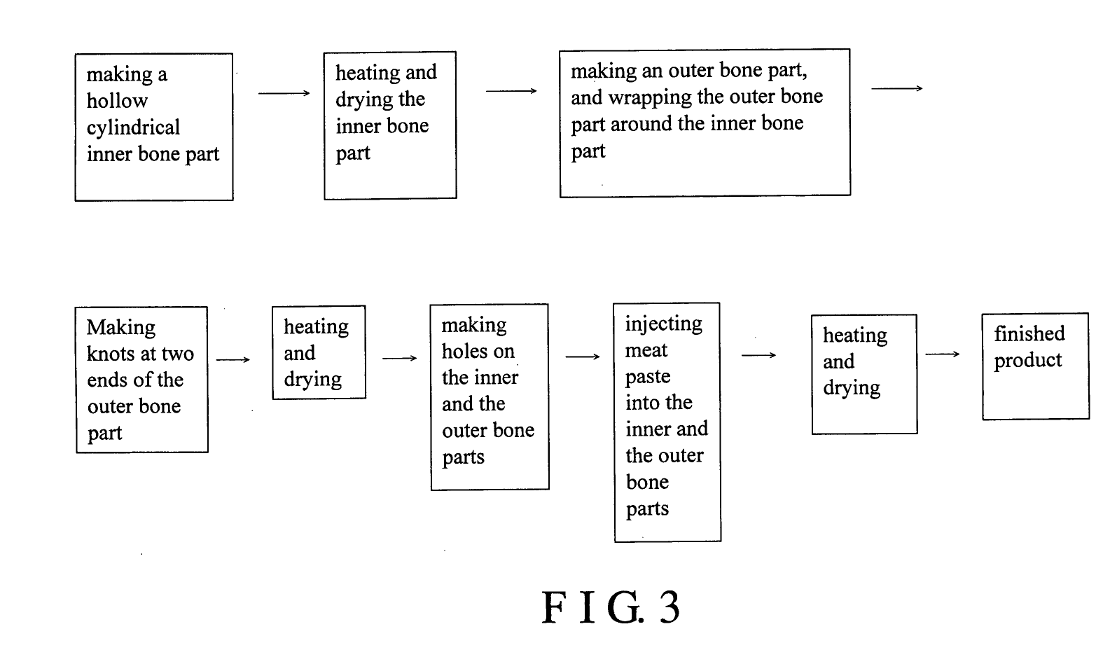

Referring to FIG. 3, a preferred embodiment of a method for making a dog bone treat in the present invention includes the following steps:
(1) making a hollow cylindrical inner bone part 3 from a first material, which is preferably a cowhide; the inner bone part 3 having a holding room 32 therein;
(2) heating and drying the inner bone part 3 by means of a machine;
(3) making an outer bone part 4 from a second material, which is longer than the first cowhide and preferably a cowhide, and wrapping the outer bone part 4 around the inner bone part 3;
(4) making knots at two ends of the outer bone part 4 to cover two ends of the inner bone part 3; there being a space between the inner and the outer bone parts 3 and 4;
(5) heating and drying the outer bone part 4;
(6) making holes 31, and 42 on the inner and the outer bone parts 3, and 4 respectively so that the hole 31 communicates with the holding room 32 of the inner bone part 3, and the hole 42 is aligned with the hole 31;
(7) injecting meat paste into the holding room 32, and the space between the inner and the outer bone parts 3 and 4 via the holes 31 and 42; and
(8) heating and drying the meat paste with a machine so that a meat paste portion 5 is formed.

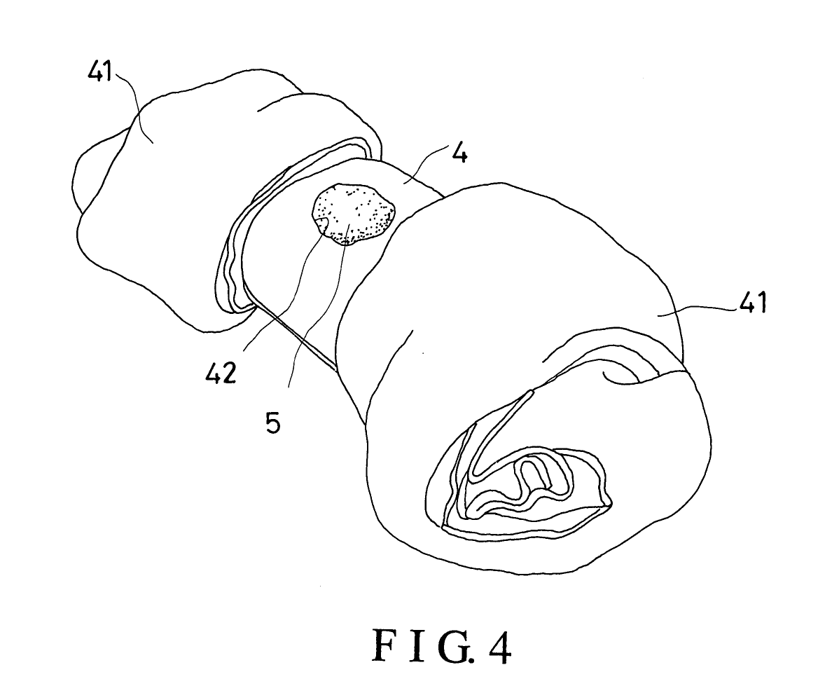

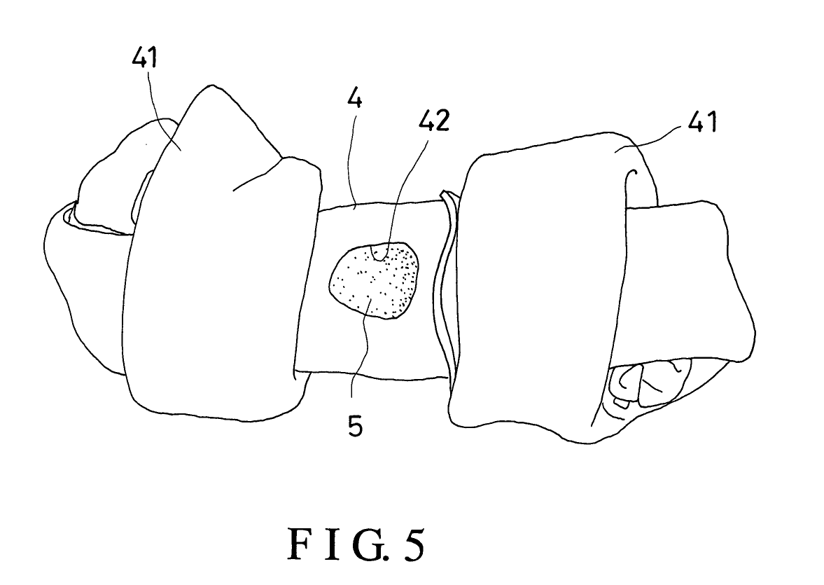

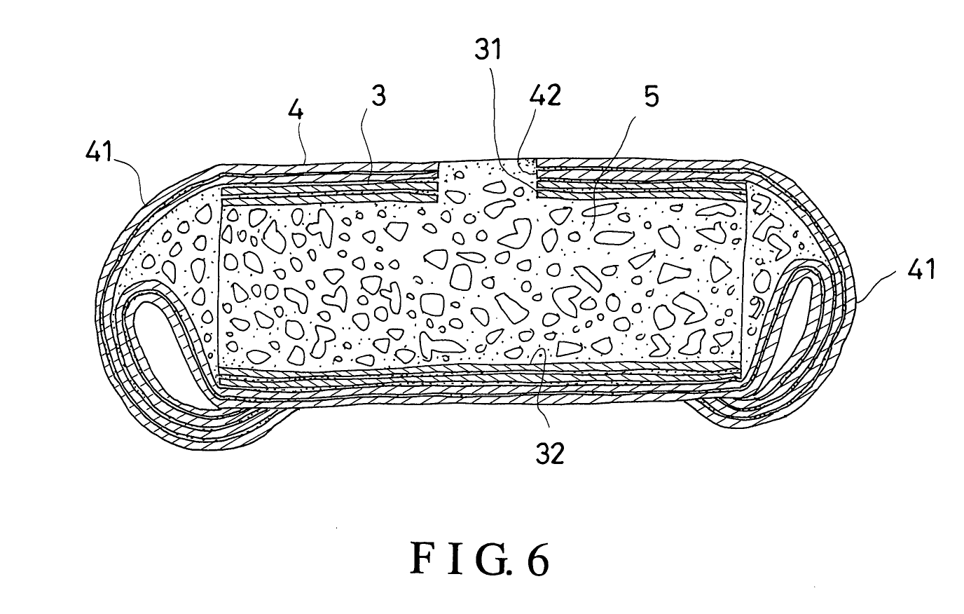

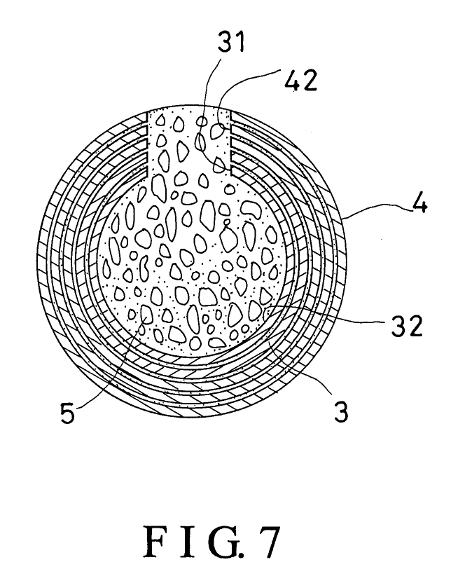

Therefore, referring to FIGS. 4 to 7, a dog bone treat according to the present invention includes inner bone part 3, an outer bone part 4, and meat paste portion 5, wherein the inner bone part 3 is a hollow cowhide cylinder with a holding room 32, and a hole 31 communicating with the holding room 32; the outer bone part 4 is made of a cowhide, and wrapped around the inner bone part 4, having knots 41 at two ends as well as a hole 42 aligned with, and in communication with the hole 31 of the inner bone part 3; the meat paste portion 5 is formed by means of heating and drying meat paste, which is injected in the holding room 32 as well as a space between the inner and the outer bone parts 3 and 4 via the holes 31 and 42; the inner bone part 3 and the outer bone part 4 are heated and dried as well.

When the bone treat of the present invention is given to a dog, the dog will be attracted to chewing on the bone treat because it can smell, and eat the meat paste. Consequently, teeth and gums of the dog can be effectively cleaned.

Because the meat paste portion 5 is held in the holding room 32 as well as the space between the inner and the outer bone parts 3 and 4, it won't be eaten up before the bone parts 3 and 4 are eaten up. Therefore, the bone treat has a long service life.

Furthermore, because those portions of the meat paste that are held in the holes 42 are not covered, consumers can easily tell the flavors of bone treats, and choose according to their dogs' preference. And, flavorings can be used instead of meat paste.

From the above description, it can be easily understood that the dog bone treat of the present invention has overcome the disadvantages of conventional dog bone treats as described in the Background.

1. A dog bone treat, comprising
an inner bone part having a holding room therein, and a hole in communication with the holding room;
an outer bone part wrapped around the inner bone part; the outer bone part having knots at two ends thereof, and a hole aligned with the hole of the inner bone part; and
meat paste portion held in the holding room of the inner bone part as well as a space between the inner and the outer bone parts.

2. A method for making a dog bone treat, comprising the steps of:
making a hollow inner cylindrical bone part from a first material, and heating and drying the inner cylindrical bone part;
making an outer bone part from a second material, and wrapping the outer bone part around the inner bone part;
making knots at two ends of the outer bone part to cover two ends of the inner bone part;
heating and drying the outer bone part;
making first and second holes on the outer and the inner bone parts respectively such that the second hole communicates with a holding room of the inner bone part, and such that the first hole is aligned with the second hole;
injecting meat paste into the holding room, and a space between the inner and the outer bone parts via the first and the second holes; and
heating and drying the meat paste.

3. The method for making a dog bone treat as claimed in claim 2, wherein the first and the second materials are cowhides.
